(19) United States
(12) Patent Application Publication
(10) Pub. No.: US 2023/0377399 A1
(43) Pub. Date: Nov. 23, 2023

(54) AUTHENTICATION METHOD, STORAGE MEDIUM, AND INFORMATION PROCESSING DEVICE

(71) Applicant: Fujitsu Limited, Kawasaki-shi (JP)

(72) Inventors: Hidenobu ITO, Kawasaki (JP); Akira FUJII, Machida (JP)

(73) Assignee: Fujitsu Limited, Kawasaki-shi (JP)

(21) Appl. No.: 18/358,338

(22) Filed: Jul. 25, 2023

Related U.S. Application Data
(63) Continuation of application No. PCT/JP21/07473, filed on Feb. 26, 2021.

(51) Int. Cl. G07C 9/37; G07C 9/15; G07C 9/38

(52) U.S. Cl. CPC G07C 9/37; G07C 9/15; G07C 9/38

(57) ABSTRACT

An authentication method for a computer to execute a process includes determining whether a face image that satisfies a first criterion is included in a first captured image captured by a camera that is provided so as to include a face of a person who is about to pass through a gate in an imaging range, when biometric information is acquired by a sensor provided in the gate; when the face image that satisfies the first criterion is included, performing authentication by using the face image included in the first captured image and the biometric information; when the face image that satisfies the first criterion is not included, instructing the camera to capture a second image; and performing authentication by using a face image included in the second captured image and the biometric information.

### CROSS-REFERENCE TO RELATED APPLICATION

This application is a continuation application of International Application PCT/JP2021/007473 filed on Feb. 26, 2021 and designated the U.S., the entire contents of which are incorporated herein by reference.

### FIELD

The present case relates to an authentication method, a storage medium, and an information processing device.

### BACKGROUND

There has been disclosed a biometric authentication technique for narrowing candidates through authentication using first biometric information (for example, facial features) and performing personal authentication by authentication using second biometric information (for example, palm vein features) (for example, see Patent Document 1).
Patent Document 1: Japanese Laid-open Patent Publication No. 2019-128880

### SUMMARY

### Technical Problem

According to an aspect of the embodiments, an authentication method for a computer to execute a process includes determining whether a face image that satisfies a first criterion is included in a first captured image captured by a camera that is provided so as to include a face of a person who is about to pass through a gate in an imaging range, when biometric information is acquired by a sensor provided in the gate; when the face image that satisfies the first criterion is included, performing authentication by using the face image included in the first captured image and the biometric information; when the face image that satisfies the first criterion is not included, instructing the camera to capture a second image; and performing authentication by using a face image included in the second captured image and the biometric information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating multi-biometric authentication processing;

FIG. 2A is a diagram illustrating an example of a gate arranged at an entrance of a store, a building, or the like, and FIG. 2B is a diagram illustrating an example of an image displayed on a display device provided near the gate;

FIG. 3 is a block diagram illustrating an overall configuration of a multi-biometric authentication system according to a first embodiment;

FIG. 4 is a functional block diagram of a control unit of a gate management system and a server;

FIG. 5A is a diagram illustrating an example of data stored in a facial feature DB, FIG. 5B is a diagram illustrating an example of data stored in a list storage unit, and FIG. 5C is a diagram illustrating an example of data stored in a vein DB;

FIG. 6 is a flowchart (part 1) illustrating an example of processing executed by the multi-biometric authentication system;

FIG. 7 is a flowchart (part 2) illustrating the example of the processing executed by the multi-biometric authentication system;

FIG. 8 is a flowchart (part 3) illustrating the example of the processing executed by the multi-biometric authentication system;

FIG. 9 is a flowchart (part 4) illustrating the example of the processing executed by the multi-biometric authentication system;

FIG. 10 is a flowchart illustrating an example of processing according to a modification of the first embodiment;

FIG. 11 is a flowchart (part 1) illustrating an example of processing according to a second embodiment;

FIG. 12 is a flowchart (part 2) illustrating the example of the processing according to the second embodiment;

FIG. 13 is a flowchart (part 3) illustrating the example of the processing according to the second embodiment;

FIG. 14 is a flowchart (part 4) illustrating the example of the processing according to the second embodiment;

FIG. 15 is a flowchart illustrating an example of processing according to a modification of the second embodiment; and

FIG. 16A is a block diagram illustrating a hardware configuration of the control unit of the gate management system, and FIG. 16B is a block diagram illustrating a hardware configuration of the server.

### DESCRIPTION OF EMBODIMENTS

It is conceivable to acquire a user's face image with a camera, narrow candidates, read biometric information registered for the narrowed candidates, and perform multi-biometric authentication processing for collating the read biometric information with biometric information acquired from the user.

Here, in order to reduce operations of the user, it is desirable to prevent processing for requesting the user to provide information necessary for authentication (face image and vein image).

In one aspect, an object of the present invention is to provide an authentication method, an authentication program, and an information processing device that can suppress operational complexity of multi-biometric authentication.

It is possible to suppress operational complexity of multi-biometric authentication.

Prior to description of embodiments, multi-biometric authentication that narrows a search set with a first modality and specifies a user with another modality will be described.

Biometric authentication is a technique for performing personal authentication using biometric features such as fingerprints, faces, and veins. In the biometric authentication, the personal authentication is performed by comparing (collating) collation biometric information acquired by a sensor with registered biometric information registered in advance in a situation where verification is needed, and determining whether or not a similarity is equal to or higher than an identity verification threshold value. The biometric authentication is used in various fields such as bank ATMs or access control.

The biometric authentication includes 1:1 authentication that verifies coincidence with registered biometric information specified by an ID, a card, or the like, and 1:N authentication that searches for coincident registered biometric information from a plurality of pieces of registered biometric information. In stores, or the like, 1:N authentication is often desired from the viewpoint of convenience. However, since the biometric information fluctuates depending on an acquisition state or the like, a possibility of erroneous collation increases as the number of pieces of registered biometric information to be searched for increases. Therefore, an operation of narrowing the information with a simple PIN code or the like to make a search set be sufficiently small, and then performing 1:N authentication is conducted. How small the search set should be to reach a practical level depends on a biometric authentication method. However, even if the operation is simple, the PIN code input impairs convenience. Therefore, a biometric authentication system that does not need an ID or card is desired.

Therefore, a method for using a plurality of types of modality has been proposed, in which a search set is narrowed with the first modality, and a user is specified with the second modality. The modality is a type of biometric feature, such as a fingerprint, vein, iris, face shape, or palm shape, for example. Therefore, a fingerprint and a vein of the same finger are of different types of modality. Since it is inconvenient to individually input a plurality of types of modality, a method for acquiring a palm vein at the same time as fingerprint input, a method for capturing a face image at the time of palm vein input, or the like have been proposed.

As an example, a method for narrowing candidates through face authentication in first authentication and specifying the person using a palm vein in second authentication will be described. With this method, for example, processing for creating a user ID list of N people to be candidates in the face authentication, performing 1:N authentication using the palm vein in a set of the obtained user ID list, and specifying a user is executed.

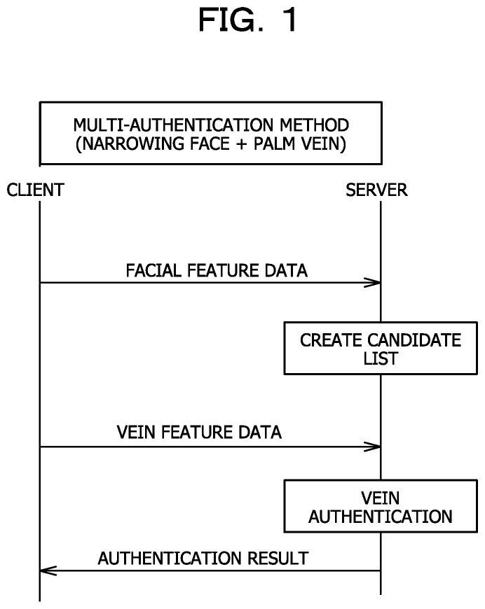

For example, as illustrated in FIG. 1, a client acquires facial feature data from a camera and sends the facial feature data to a server. The server collates each registered facial feature data and the acquired facial feature data, for a plurality of users whose facial feature data and vein feature data are registered in advance. The server extracts a user ID having a similarity equal to or more than a threshold and creates a candidate list including the extracted user ID.

Next, the client acquires vein feature data from a vein sensor and sends the vein feature data to the server. The server collates the acquired vein feature data with registered vein feature data having the user ID written in the candidate list. The server determines that the authentication is succeeded if the user ID having the similarity equal to or more than the threshold exists and determines that the authentication fails if the user ID having the similarity equal to or more than the threshold does not exist. The server sends a result of this second authentication to the client. In such multi-biometric authentication, by narrowing the candidates of the vein authentication that needs a longer processing time, it is possible to shorten a time before the person is authenticated.

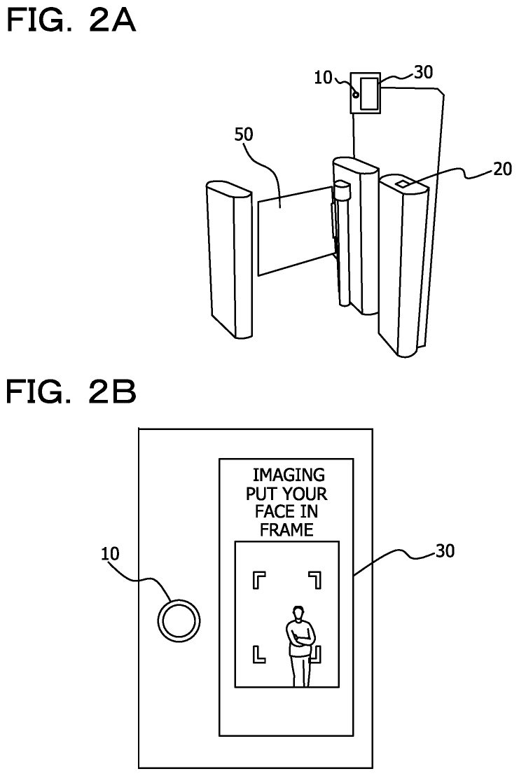

Such a multi-authentication system is used to manage a gate arranged at an entrance of a store, a building, or the like, illustrated in FIG. 2A, for example. In other words, a camera 10 that captures a face image and a vein sensor 20 that acquires a palm vein image (hereinafter, described as vein image) are provided at the entrance of the store, and the multi-biometric authentication is performed at the time of entry to the store. Then, the personal authentication is succeeded, a door 50 opens, and a user can enter the store.

In a case where the personal authentication fails, the door 50 remains to be closed, for example, a message such as “authentication fails” is displayed on a display device 30, and the face image and the vein image are acquired again. At this time, the user is requested to face the camera 10 and place the palm on the vein sensor 20 again. However, in a case where the personal authentication fails, regardless of the cause, when re-acquisition of both of the face image and the vein image is requested, this causes complexity, and the user feels stress.

Therefore, in the following embodiments, an authentication method, an authentication program, and an information processing device that can suppress operational complexity of multi-biometric authentication will be described.

### First Embodiment

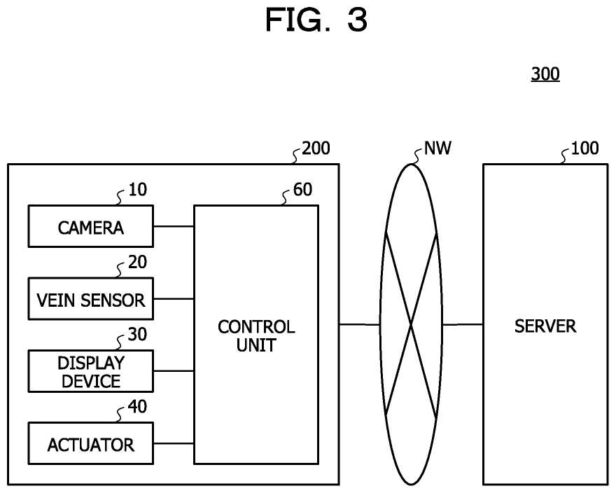

FIG. 3 is a block diagram illustrating an overall configuration of a multi-biometric authentication system 300 according to a first embodiment.

As illustrated in FIG. 3, the multi-biometric authentication system 300 has a configuration in which a server 100 and a gate management system 200 are coupled via a network NW such as the Internet or a local area network (LAN). The server 100 functions as an information processing device according to the present embodiment. In the present embodiment, as an example, a case will be described where to open/close a gate (refer to FIG. 2A) provided at an entrance of a store needs authentication processing.

The gate management system 200 includes a camera 10, a vein sensor 20, a display device 30, an actuator 40, a control unit 60, or the like.

For example, as illustrated in FIG. 2A, the camera 10 is provided near the gate provided at the entrance of the store and captures an image including a face of a user who is about to pass through the gate.

For example, as illustrated in FIG. 2A, the vein sensor 20 is provided at the gate, and the user can hold a palm over the vein sensor 20 at a timing when the user enters the store. The vein sensor 20 captures a palm vein image of the user.

The display device 30 is, for example, a liquid crystal display, and displays an image being captured by the camera 10 or displays a message to the user, under control of the control unit 60.

The actuator 40 opens/closes a door 50 of the gate, under the control of the control unit 60.

The control unit 60 acquires information necessary for multi-biometric authentication, using the camera 10 and the vein sensor 20, and transmits the information to the server 100. Furthermore, the control unit 60 controls the camera 10, the vein sensor 20, the display device 30, and the actuator 40, based on an authentication result received from the server 100.

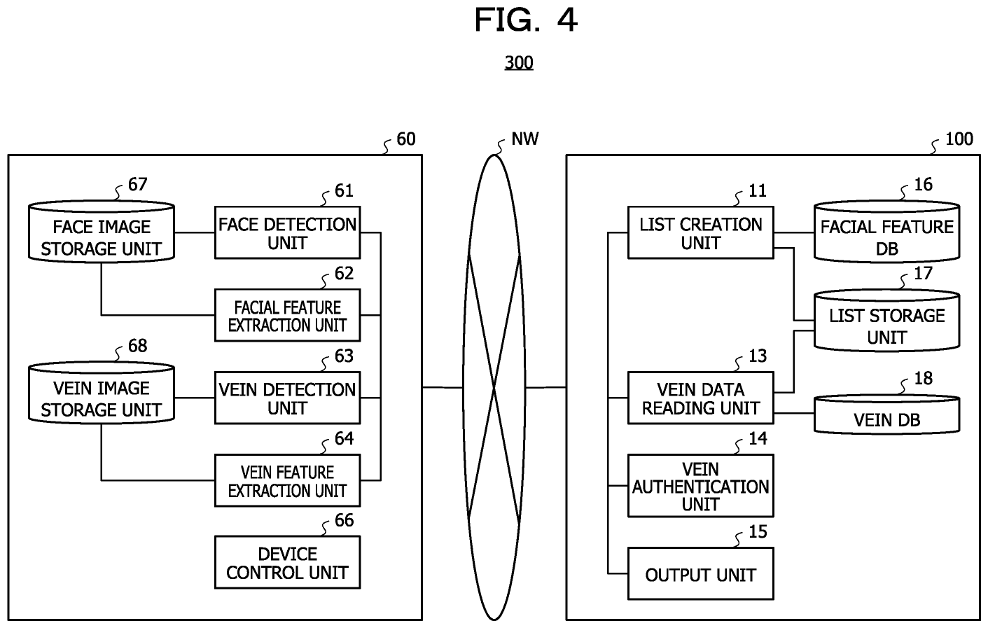

FIG. 4 is a functional block diagram of the control unit 60 of the gate management system 200 and the server 100.

The control unit 60 includes a face detection unit 61, a facial feature extraction unit 62, a vein detection unit 63, a vein feature extraction unit 64, a device control unit 66, a face image storage unit 67, and a vein image storage unit 68. Note that the face detection unit 61, the facial feature extraction unit 62, the vein detection unit 63, the vein feature extraction unit 64, the face image storage unit 67, and the vein image storage unit 68 may be included in the server 100.

The face detection unit 61 detects a face from an image captured by the camera 10.

The facial feature extraction unit 62 extracts facial feature data from face image data stored in the face image storage unit 67 or face image data acquired from the image captured by the camera 10. The facial feature extraction unit 62 sends the extracted facial feature data to a list creation unit 11 via the network NW.

The vein detection unit 63 detects a vein from the vein image captured by the vein sensor 20.

The vein feature extraction unit 64 extracts vein feature data from vein image data. The vein feature extraction unit 64 transmits the extracted vein feature data to a vein authentication unit 14 via the network NW.

The device control unit 66 controls the camera 10, the vein sensor 20, the display device 30, and the actuator 40, based on the authentication result or an instruction received from the server 100.

The face image storage unit 67 stores the image captured by the camera 10 or the face image data acquired from the image captured by the camera 10.

The vein image storage unit 68 stores the vein image captured by the vein sensor 20 or the vein data acquired from the vein image.

The server 100 includes the list creation unit 11, a vein data reading unit 13, the vein authentication unit 14, an output unit 15, a facial feature DB 16, a list storage unit 17, and a vein DB 18.

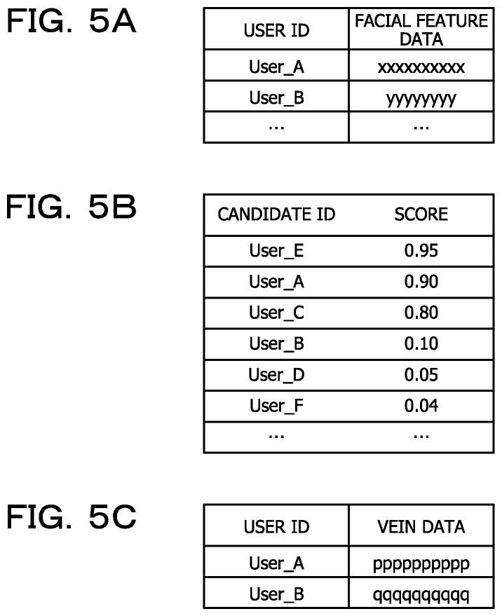

As illustrated in FIG. 5A, the facial feature database (DB) 16 stores a user ID of each user in association with facial feature data of each user.

The list creation unit 11 receives the facial feature data of the user from the facial feature extraction unit 62. The list creation unit 11 calculates a similarity between the facial feature data of each user read from the facial feature DB 16 and the received facial feature data as a score and extracts a user ID, of which the score is equal to or more than a threshold, as a candidate ID so as to create a candidate list and store the candidate list in the list storage unit 17.

As illustrated in FIG. 5B, the list storage unit 17 stores the candidate list in which each candidate ID is associated with the score calculated by the list creation unit 11.

When receiving the vein feature data from the vein feature extraction unit 64, the vein data reading unit 13 reads vein data of a candidate included in the candidate list stored in the list storage unit 17, from the vein DB 18.

As illustrated in FIG. 5C, the vein DB 18 stores the user ID of each user in association with the facial feature data of each user.

The vein authentication unit 14 performs vein authentication using the vein feature data received by the vein data reading unit 13 and the vein data read by the vein data reading unit 13. For example, the vein authentication unit 14 calculates a similarity between the received vein feature data and the read vein data and, in a case where there is vein data of which the similarity is equal to or more than a threshold, the vein authentication unit 14 determines that the authentication is succeeded. Note that, the threshold in this case is set to be a higher value with which one user is specified.

The output unit 15 transmits a result of the authentication processing and various instructions based on the result of the authentication processing to the device control unit 66.

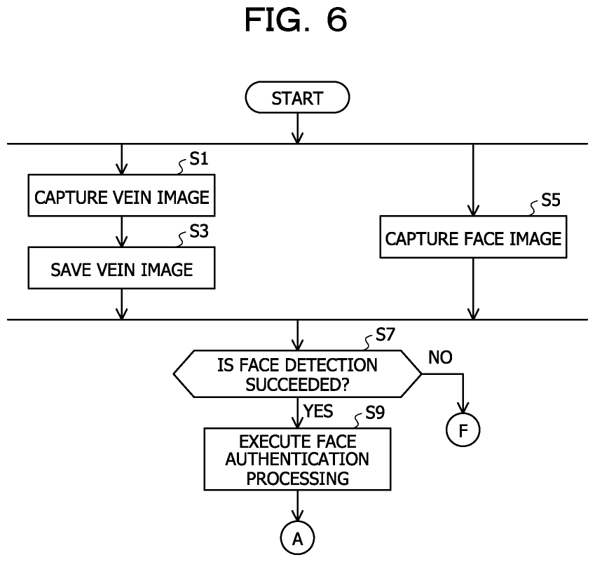

FIGS. 6 to 9 are flowcharts illustrating an example of processing executed by the multi-biometric authentication system 300. Note that, it is assumed that, at the start of this processing, data be not saved in the face image storage unit 67, the vein image storage unit 68, and the list storage unit 17. In the first embodiment, biometric information and a face image are simultaneously acquired.

The vein sensor 20 captures a vein image (step S1), and the captured vein image is saved in the vein image storage unit 68 (step S3). On the other hand, the camera 10 captures an image (step S5).

Next, the face detection unit 61 determines whether or not a face is detected in the image captured by the camera 10 (step S7). Specifically, the face detection unit 61 determines whether or not a face image is included in the image captured by the camera 10.

In a case where the face is not detected (step S7/NO), the procedure proceeds to step S35 to be described later. On the other hand, in a case where the face is detected (step S7/YES), face authentication processing using face image data acquired from the image captured in step S5 is executed (step S9).

Specifically, the facial feature extraction unit 62 extracts facial feature data from the face image data acquired from the image captured in step S5 and transmits the facial feature data to the list creation unit 11. The list creation unit 11 reads facial feature data of each user from the facial feature DB 16 and calculates a similarity between the received facial feature data and the facial feature data of each user as a score. Then, the list creation unit 11 creates a candidate list (refer to FIG. 5B) by extracting a user ID of which the score is equal to or more than the threshold as a candidate ID and stores the candidate list in the list storage unit 17. Note that, in the present embodiment, it is assumed that, in a case where there is no user whose score is equal to or more than the threshold, the list creation unit 11 do not create the candidate list. Therefore, in a case where there is no user whose score is equal to or more than the threshold, the candidate list is not stored in the list storage unit 17, and the list storage unit 17 remains empty. The reason why there is no user whose score is equal to or more than the threshold, it is considered that the face image included in the image captured in step S5 does not satisfy a criterion necessary for face authentication.

Next, the vein detection unit 63 determines whether or not the face authentication processing is succeeded (step S30). For example, in a case where the candidate list is stored in the list storage unit 17, the vein detection unit 63 determines that the face authentication processing is succeeded. In a case where the face authentication processing is succeeded (step S30/YES), the vein detection unit 63 determines whether or not a vein is detected in a vein image saved in the vein image storage unit 68 (step S31).

In a case where the vein is not detected (step S31/NO), it is not possible to execute vein authentication processing. Therefore, the procedure proceeds to step S53 to be described later. On the other hand, in a case where the vein is detected (step S31/YES), the vein authentication processing is executed (step S32).

Specifically, the vein feature extraction unit 64 extracts vein feature data from vein image data acquired from the vein image saved in the vein image storage unit 68 and transmits the vein feature data to the vein authentication unit 14. The vein data reading unit 13 reads vein data of the candidate included in the candidate list stored in the list storage unit 17, from the vein DB 18. The vein authentication unit 14 performs vein authentication by calculating a similarity between the received vein data and the read vein data.

The output unit 15 determines whether or not the vein authentication is succeeded (step S33). For example, in a case where the highest similarity among the calculated similarities is equal to or more than the threshold, the output unit 15 determines that the authentication is succeeded.

In a case where the vein authentication is succeeded (step S33/YES), processing for permitting entry to the store is executed (step S34), and the processing illustrated in FIGS. 6 to 9 ends. Specifically, the output unit 15 transmits information indicating that the authentication processing is succeeded to the device control unit 66 of the gate management system 200. When receiving the information indicating that the authentication processing is succeeded, the device control unit 66 controls the actuator 40 and opens the door 50 of the gate. As a result, the user can enter the store.

On the other hand, in a case where the vein authentication fails (step S33/NO), the procedure proceeds to step S53 to be described later.

By the way, in a case where it is not possible to detect the face in the image captured by the camera 10 in step S5 (step S7/NO), or in a case where the face authentication using the face image data acquired from the image captured by the camera 10 fails (step S30/NO), the camera 10 is instructed to re-capture the face image (step S35). In other words, in a case where the face image that satisfies the criterion is not included in the image captured by the camera 10, the camera 10 is instructed to re-capture the face image (step S35).

Specifically, the output unit 15 transmits information for instructing to re-capture the face image, to the device control unit 66. The device control unit 66 causes the camera 10 to re-capture the face image based on the instruction.

Next, the camera 10 captures an image (step S37). The face detection unit 61 determines whether or not a face is detected in the image newly captured by the camera 10 (step S39).

In a case where the face is not detected (step S39/NO), the procedure returns to step S37. In a case where the face is detected (step S39/YES), the face authentication processing is executed (step S41).

Specifically, the facial feature extraction unit 62 extracts facial feature data from face image data acquired from the image newly captured by the camera 10 and transmits the facial feature data to the list creation unit 11. The list creation unit 11 creates a candidate list using the received facial feature data and stores the candidate list in the list storage unit 17.

Next, the vein data reading unit 13 determines whether or not the face authentication processing is succeeded, as in step S30 (step S43). In a case where the face authentication processing fails (step S43/NO), the procedure returns to step S37.

On the other hand, in a case where the face authentication processing is succeeded (step S43/YES), as in steps S31 and S32, the vein authentication using the vein image saved in the vein image storage unit 68 is performed (steps S45 and S47). In this way, in a case where the face authentication cannot be performed or the face authentication fails because the face image that satisfies the criterion is not included in the image captured by the camera 10, the vein authentication is performed using the vein image saved in the vein image storage unit 68, without re-capturing the vein image. Therefore, it is possible to prevent processing for requesting the user to re-acquire the vein image, and an unnecessary operation (operation for re-acquiring vein image) is not forced to the user. As a result, operational complexity of multi-biometric authentication can be suppressed, and stress of the user can be reduced.

The output unit 15 determines whether or not the vein authentication is succeeded, as in step S33 (step S49). In a case where the vein authentication is succeeded (step S49/YES), as in step S34, the processing for permitting the entry to the store is executed (step S51), and the processing illustrated in FIGS. 6 to 9 ends.

On the other hand, in a case where the vein authentication fails, it is not possible to specify whether the vein authentication fails because a candidate list that does not include the user due to a problem of the face image data is created although the face authentication processing is succeeded or whether the vein authentication fails due to a problem of the vein image data. Therefore, in a case where the vein authentication fails (step S33/NO, step S51/NO), processing for re-acquiring both of the face image and the vein image is executed.

Specifically, first, as in step S35, the camera 10 is instructed to re-capture the face image (step S53).

Next, as in steps S37 to S43, processing in steps S55 to S61 is executed.

Next, when the face authentication processing is succeeded (step S61/YES), the vein sensor 20 is instructed to re-capture the vein image (step S63). Specifically, the output unit 15 transmits information for instructing to re-capture the vein image, to the device control unit 66. The device control unit 66 displays a message for requesting the user to place the palm on the display device 30 again, for example, based on the instruction and causes the vein sensor 20 to capture the vein image.

The vein sensor 20 newly captures the vein image (step S65). The vein detection unit 63 executes vein detection processing on the vein image (step S66) and determines whether or not the vein can be detected (step S67). In a case where the vein cannot be detected (step S67/NO), the procedure returns to step S65.

In a case where the vein can be detected (step S67/YES), vein authentication processing using the newly captured vein image is executed (step S69). Specifically, the vein feature extraction unit 64 extracts vein feature data from vein image data acquired from the vein image newly captured by the vein sensor 20 and transmits the vein feature data to the vein authentication unit 14. The vein data reading unit 13 reads vein data of the candidate included in the candidate list stored in the list storage unit 17, from the vein DB 18. The vein authentication unit 14 performs vein authentication by calculating a similarity between the received vein data and the read vein data.

Thereafter, as in steps S33 and S49, the output unit 15 determines whether or not the vein authentication is succeeded (step S71). In a case where the vein authentication is succeeded (step S71/YES), as in steps S34 and S51, the processing for permitting the entry to the store is executed (step S73), and the processing illustrated in FIGS. 6 to 9 ends.

On the other hand, in a case where the vein authentication fails (step S71/NO), personal authentication failure processing is executed (step S75), and the processing illustrated in FIGS. 6 to 9 ends.

In the personal authentication failure processing, for example, the output unit 15 transmits information indicating that the personal authentication fails, to the device control unit 66. When receiving the information indicating that the personal authentication fails, the device control unit 66 displays a message such as “authentication has failed” on the display device 30. At this time, a message instructing the user to perform authentication for entering the store using another method (for example, QR code (registered trademark)) may be displayed.

When the processing in FIGS. 6 to 9 ends, the display device 30 is, for example, in a standby state, and the image captured by the camera 10 is not displayed on the display device 30.

As described above, in the first embodiment, in a case where the face image that satisfies the criterion is included in the image captured by the camera 10, when the vein image is acquired (step S7/YES and step S30/YES), the multi-biometric authentication is performed using the acquired vein image and face image. On the other hand, in a case where the face image that satisfies the criterion is not included in the image captured by the camera 10 (step S7/NO or step S30/NO), the camera 10 is instructed to re-capture an image (step S35). Then, the multi-biometric authentication is performed using an image included in the image newly captured by the camera 10 and the vein image stored in the vein image storage unit 68. In this way, since the vein image is not re-acquired in a case where the face image has a problem, an unnecessary operation is not forced to the user. As a result, the operational complexity of multi-biometric authentication can be suppressed, and the stress of the user can be reduced.

(Modification)

The processing for acquiring the face image data may be repeated until the vein image is captured by the vein sensor 20. Note that, in a modification, the display device 30 is in a standby state at the normal time, for example, and an image captured by the camera 10 is not displayed. When a face image is re-captured by the camera 10, the image being captured by the camera 10 is displayed on the display device 30.

When the image being captured by the camera 10 is constantly displayed on the display device 30 provided near the camera 10, an image of a user is displayed (refer to FIG. 2B) on the display device 30 before the user approaches a gate. Therefore, there is a case where the user feels uncomfortable as if the user is being monitored. In the present embodiment, since the image being captured by the camera 10 is not displayed on the display device 30 at the normal time, uncomfortable feeling of the user can be reduced, as compared with a case where the image being captured by the camera 10 is constantly displayed on the display device 30. Furthermore, since the user does not feel that the user is imaged, a natural behavior of the user is not disturbed. Moreover, the user can use the multi-biometric authentication, without being aware of that the face is imaged.

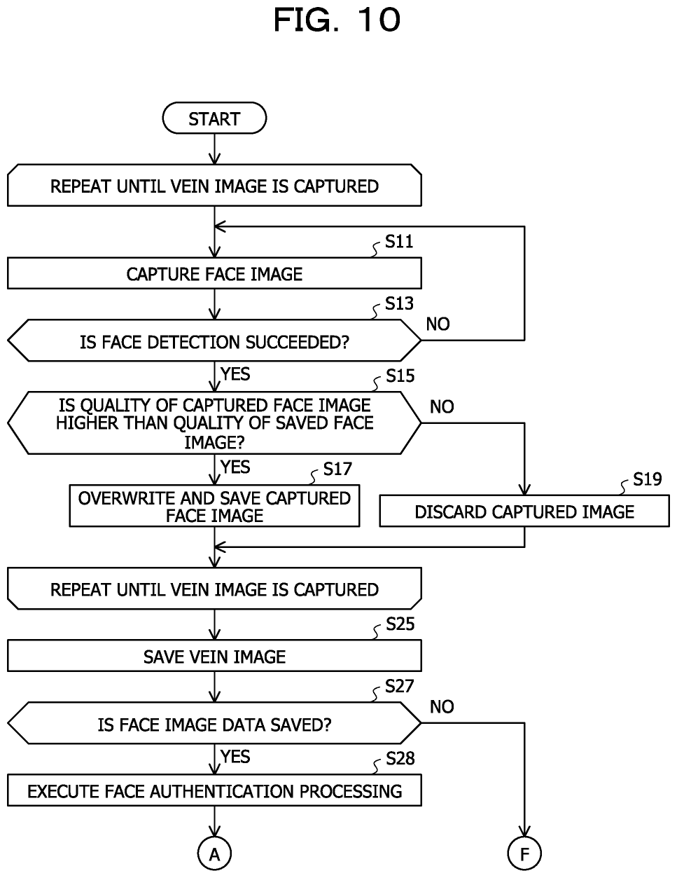

FIG. 10 is a flowchart illustrating an example of processing according to the modification of the first embodiment. In the processing in FIG. 10, first, the camera 10 captures an image (step S11). The face detection unit 61 determines whether or not a face is detected in the image captured by the camera 10, at a predetermined sampling period (step S13).

In a case where the face is not detected (step S13/NO), the procedure returns to step S11. In a case where the face is detected (step S13/YES), the face detection unit 61 determines whether or not quality of the face image included in the captured image is higher than quality of the face image stored in the face image storage unit 67 (step S15).

In a case where the quality of the captured face image is lower than the quality of the face image stored in the face image storage unit 67 (step S15/NO), the face detection unit 61 discards the captured image (step S19). On the other hand, in a case where the quality of the captured face image is higher than the quality of the face image stored in the face image storage unit 67 (step S15/YES), face image data acquired from the captured image is overwritten and saved in the face image storage unit 67 (step S17). Note that, in a case where the face image data is not stored in the face image storage unit 67, the determination in step S15 is affirmed regardless of the quality of the acquired face image, and the face image data acquired from the captured image is stored in the face image storage unit 67.

The processing in steps S11 to S19 is repeated until the vein sensor 20 captures the vein image. According to the processing in steps S15 to S19, face image data with the highest quality, among the face image data of the user, is stored in the face image storage unit 67. As a result, since a success probability of the face authentication increases, and a possibility of acquiring the face image again is reduced. Therefore, processing for acquiring the face image again can be prevented. In other words, a possibility for forcing the unnecessary operation (operation for re-acquiring face image) to the user can be reduced, and the complexity at the time of authentication can be suppressed.

Note that, in a case where the image including the face image of the user is not captured before the vein sensor 20 captures the vein image, the face image data is not stored in the face image storage unit 67, and the face image storage unit 67 remains empty.

When the vein sensor 20 captures the vein image, the procedure proceeds to step S25, and the vein detection unit 63 stores the vein image in the vein image storage unit 68.

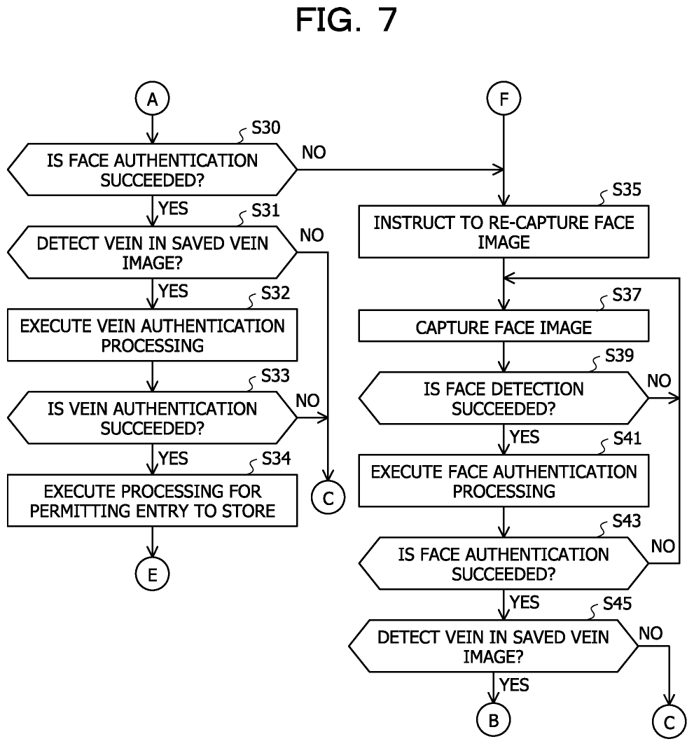

Next, the facial feature extraction unit 62 determines whether or not the face image data is stored in the face image storage unit 67 (step S27). In a case where the face image data is not saved (step S27/NO), this means that the image including the face image cannot be acquired. In this case, in order to re-capture the face image, the processing from step S35 in FIG. 7 is executed.

On the other hand, in a case where the face image data is saved (step S27/YES), the face authentication processing using the face image data saved in the face image storage unit 67 is executed (step S28).

Specifically, the facial feature extraction unit 62 extracts the facial feature data from the face image data saved in the face image storage unit 67 and transmits the facial feature data to the list creation unit 11. The list creation unit 11 reads facial feature data of each user from the facial feature DB 16 and calculates a similarity between the received facial feature data and the facial feature data of each user as a score. Then, the list creation unit 11 creates a candidate list by extracting a user ID of which the score is equal to or more than the threshold as a candidate ID and stores the candidate list in the list storage unit 17.

Thereafter, the processing from step S30 in FIG. 7 is executed.

In this way, by capturing the face image at a predetermined period until the vein sensor 20 captures the vein image, a possibility that the image including the face image can be acquired increases. As a result, a possibility can be reduced that it is necessary to acquire the face image again because the face image is not included in the image captured by the camera 10. Furthermore, since the face image data with the highest quality among the captured face images is stored in the face image storage unit 67, the success probability of the face authentication increases, and the possibility of acquiring the face image again can be reduced. As a result, since the processing for acquiring the face image again can be prevented, the operational complexity of multi-biometric authentication can be further suppressed. Furthermore, as compared with a case where all the face images acquired before the vein image is captured are used, the number of candidates included in the candidate list can be reduced.

### Second Embodiment

After it is confirmed that quality of a vein image captured by a vein sensor 20 satisfies a predetermined criterion (for example, vein can be detected from vein image), face authentication processing may be started.

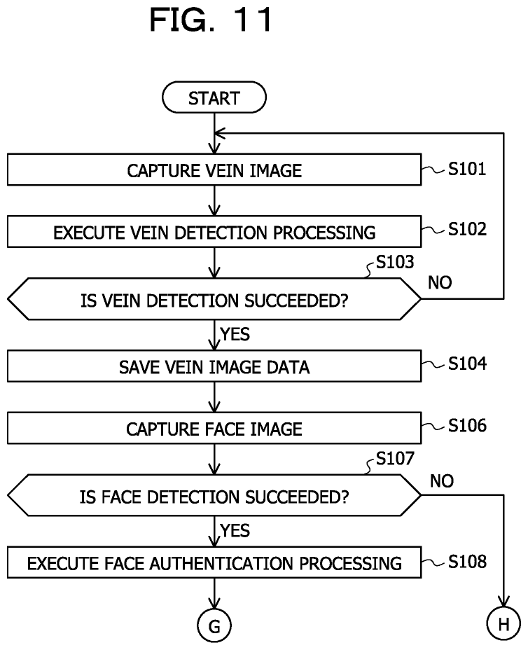

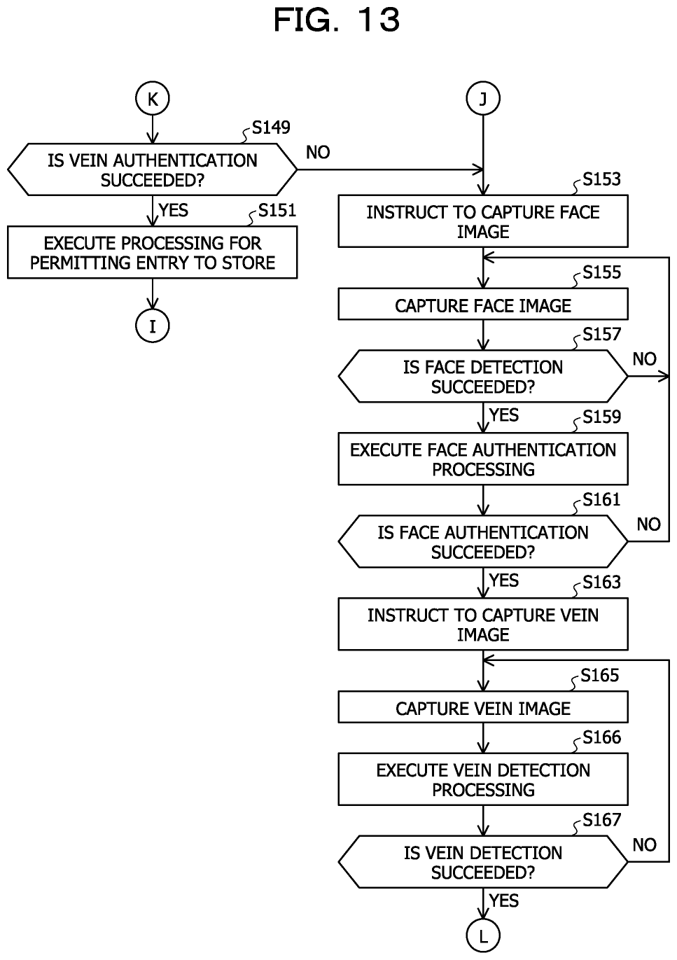

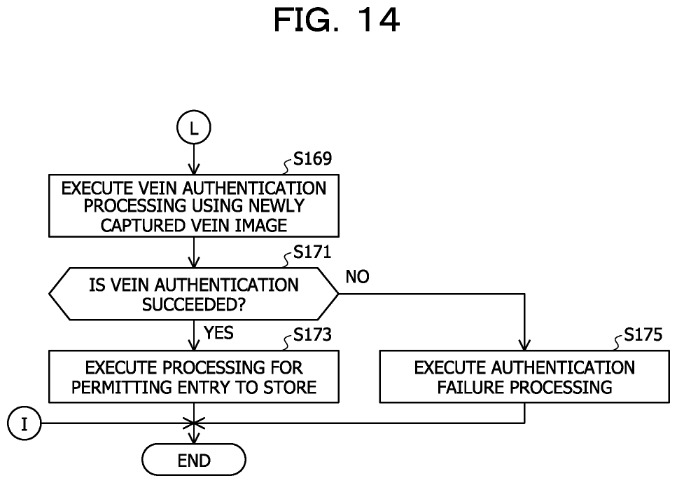

FIGS. 11 to 14 are flowcharts illustrating an example of processing according to a second embodiment.

In the processing in FIG. 11, first, the vein sensor 20 captures a vein image (step S101). Next, a vein detection unit 63 executes vein detection processing on a palm vein image captured by the vein sensor 20 (step S102). Next, the vein detection unit 63 determines whether or not vein detection is succeeded (step S103).

In a case where the vein detection fails (step S103/NO), the procedure returns to step S101. In a case where the vein detection is succeeded (step S103/YES), the vein detection unit 63 stores vein image data acquired from the vein image captured by the vein sensor 20 in step S101 in a vein image storage unit 68 (step S104).

Next, a camera 10 captures an image (step S106). Next, a face detection unit 61 determines whether or not a face is detected in the image captured by the camera 10 (step S107). Specifically, the face detection unit 61 determines whether or not a face image is included in the image captured by the camera 10.

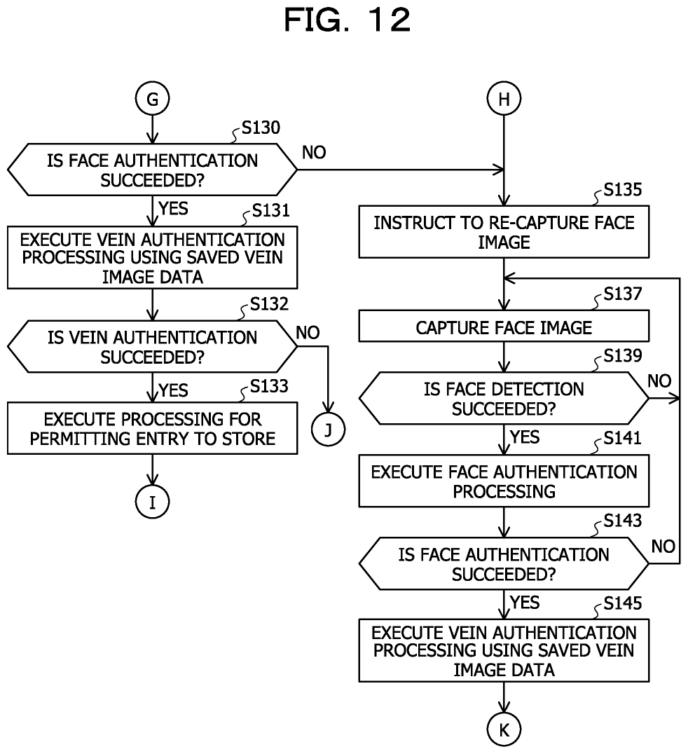

In a case where the face cannot be detected (step S107/NO), the procedure proceeds to step S135 in FIG. 12. On the other hand, in a case where the face can be detected (step S107/YES), face authentication processing using face image data acquired from the image captured by the camera 10 in step S106 is executed (step S108). Since the processing in step S108 is similar to step S9 in FIG. 6, detailed description will be omitted.

Next, a vein data reading unit 13 determines whether or not the face authentication processing is succeeded (step S130). For example, in a case where a candidate list is stored in a list storage unit 17, the vein data reading unit 13 determines that the face authentication processing is succeeded. In a case where the face authentication processing is succeeded (step S130/YES), vein authentication processing using the vein image data saved in the vein image storage unit 68 is executed (step S131).

Specifically, a vein feature extraction unit 64 extracts vein feature data from the vein image data saved in the vein image storage unit 68 and transmits the vein feature data to a vein authentication unit 14. The vein data reading unit 13 reads vein data of the candidate included in the candidate list stored in the list storage unit 17, from the vein DB 18. The vein authentication unit 14 performs vein authentication by calculating a similarity between the received vein data and the read vein data.

An output unit 15 determines whether or not vein authentication is succeeded, as in step S33 in FIG. 7 (step S132). In a case where the vein authentication is succeeded (step S132/YES), as in step S34 in FIG. 7, processing for permitting entry to a store is executed (step S133), and the processing in FIGS. 11 to 14 ends.

On the other hand, in a case where the vein authentication fails (step S132/NO), the procedure proceeds to step S153 to be described later.

In a case where the face cannot be detected in the image captured by the camera 10 in step S106 (step S107/NO), or in a case where the face authentication processing using the face image data acquired from the image captured by the camera 10 fails (step S130/NO), as in step S35 in FIG. 7, the camera 10 is instructed to re-capture the face image (step S135). In other words, in a case where a face image that satisfies a criterion is not included in the image captured by the camera 10, the camera 10 is instructed to re-capture the face image.

Thereafter, as in steps S37 to S43 in FIG. 7, the processing in steps S137 to S143 is executed.

In a case where the face authentication processing fails in step S143 (step S143/NO), the procedure returns to step S137. On the other hand, in a case where the face authentication processing is succeeded (step S143/YES), as in step S131, the vein authentication processing using the vein image data saved in the vein image storage unit 68 is executed (step S145).

As a result, in a case where the face image that satisfies the criterion is not included in the image captured by the camera 10, the face image is re-captured by the camera 10. However, the vein image data saved in the vein image storage unit 68 is used for the vein authentication. In other words, the vein image is not re-acquired. As a result, the operational complexity of multi-biometric authentication can be suppressed, and the stress of the user can be reduced.

The output unit 15 determines whether or not the vein authentication is succeeded, as in step S132 (step S149). In a case where the vein authentication is succeeded (step S149/YES), as in step S133, the processing for permitting the entry to the store is executed (step S151), the processing in FIGS. 11 to 14 ends.

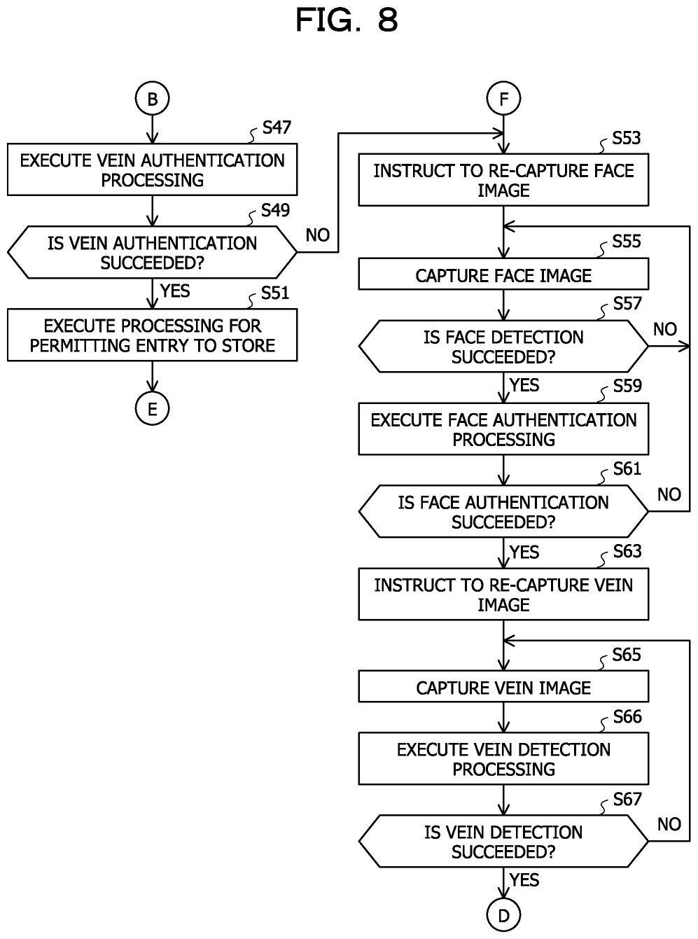

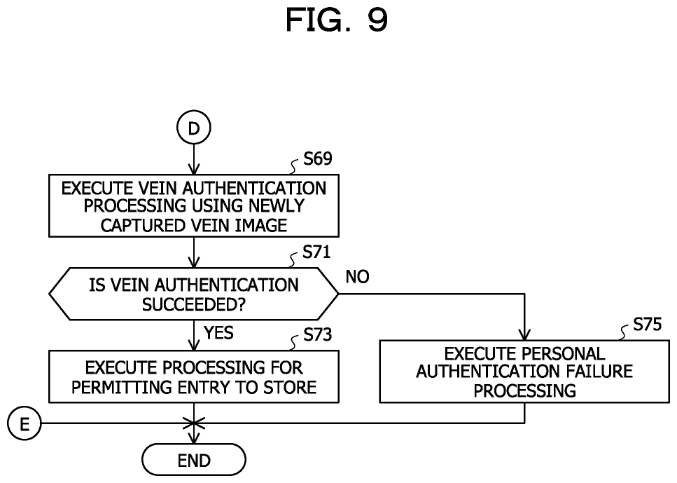

On the other hand, in a case where the vein authentication fails (step S149/NO), as in steps S53 to S75 in FIGS. 8 and 9, processing in steps S153 to S175 is executed, and the processing in FIGS. 11 to 14 ends.

In the second embodiment, the vein image data stored in the vein image storage unit 68 is image data in which a vein is detected. In other words, quality of the vein image data satisfies a predetermined criterion. As a result, it can be ensured that the vein authentication processing can be executed. Therefore, in a period from when it is instructed to re-capture the face image to the time of authentication using the face image data included in the image re-captured by the camera 10 and the vein image data (period in steps S135 to S145), the vein image is not re-acquired. As a result, an output of a message for requesting to re-acquire the vein image is prevented, and the operational complexity of multi-biometric authentication can be suppressed.

Furthermore, in the second embodiment, for example, as in the first embodiment, since it is not possible to detect the vein from the vein image (step S31/NO, step S45/NO), a possibility that both of the face image and the vein image are re-acquired can be reduced. As a result, processing for re-acquiring information necessary for authentication can be prevented, and the operational complexity of multi-biometric authentication can be suppressed.

(Modification)

In the second embodiment, processing for acquiring the face image data may be repeated, until the vein detection unit 63 detects the vein in the vein image. In a modification of the second embodiment, as in the modification of the first embodiment, it is assumed that, by being in a standby state at the normal time or the like, an image captured by the camera 10 be not displayed on the display device 30, and when a face image is re-captured by the camera 10, the image being captured by the camera 10 be displayed on the display device 30.

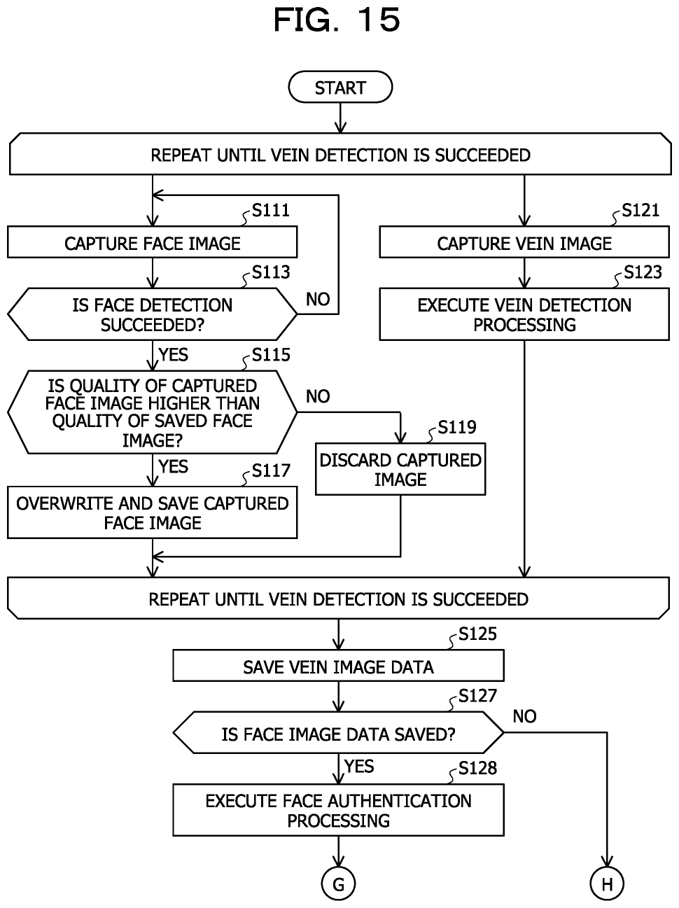

FIG. 15 is a flowchart illustrating an example of processing according to the modification of the second embodiment.

In the processing in FIG. 15, until the vein detection unit 63 detects the vein in the vein image, processing in steps S111 to S119 is repeated similarly to steps S11 to S19 in FIG. 10.

According to the processing in steps S111 to S119, face image data with the highest quality, among the face image data of the user, is stored in the face image storage unit 67. Note that, in a case where an image including a face of a user is not captured, before the vein detection unit 63 detects the vein in the vein image, face image data is not stored in the face image storage unit 67, and the face image storage unit 67 remains empty.

In parallel to the processing in steps S111 to S119, the vein sensor 20 captures a vein image (step S121). The vein detection unit 63 executes the vein detection processing on the vein image (step S123). The processing in steps S121 and S123 is repeated until the vein detection unit 63 detects the vein in the vein image.

Then, when the vein detection unit 63 detects the vein in the vein image, the vein detection unit 63 stores vein image data acquired from the vein image in which the vein is detected, in the vein image storage unit 68 (step S125).

Next, the facial feature extraction unit 62 determines whether or not the face image data is stored in the face image storage unit 67 (step S127). In a case where the face image data is not saved (step S127/NO), this means that the image including the face image cannot be acquired. In this case, in order to re-capture the face image, the processing from step S135 in FIG. 12 is executed.

On the other hand, in a case where the face image data is saved (step S127/YES), the face authentication processing using the face image data saved in the face image storage unit 67 is executed (step S128).

Specifically, the facial feature extraction unit 62 extracts the facial feature data from the face image data saved in the face image storage unit 67 and transmits the facial feature data to the list creation unit 11. The list creation unit 11 creates a candidate list, using the received facial feature data and the facial feature data of each user stored in the facial feature DB 16 and stores the candidate list in the list storage unit 17.

Thereafter, the processing from step S130 in FIG. 12 is executed.

According to the modification, by capturing an image by the camera 10 until the vein is detected in the vein image, a possibility that the image including the face image can be acquired increases. As a result, a possibility can be reduced that it is necessary to acquire the face image again because the face image is not included in the image captured by the camera 10. Furthermore, since the face image data with the highest quality among the captured face image is stored in the face image storage unit 67, a success probability of face authentication increases. As a result, since a possibility that the face image has to be acquired again can be reduced, the processing for re-acquiring the face image can be prevented, and the operational complexity of multi-biometric authentication can be further suppressed. Furthermore, as compared with a case where all the face images acquired until the vein is detected in the vein image are used, the number of candidates included in the candidate list can be reduced.

Furthermore, in the modification, the vein image data stored in the vein image storage unit 68 is the image data in which the vein is detected, as in the second embodiment. As a result, as in the second embodiment, in a period from when it is instructed to re-capture the face image to the time of authentication using the face image data included in the image re-captured by the camera 10 and the vein image data (period in steps S135 to S145), the vein image is not re-acquired. Therefore, the output of the message for requesting to re-acquire the vein image is prevented, and the operational complexity of multi-biometric authentication can be suppressed.

(Hardware Configuration)

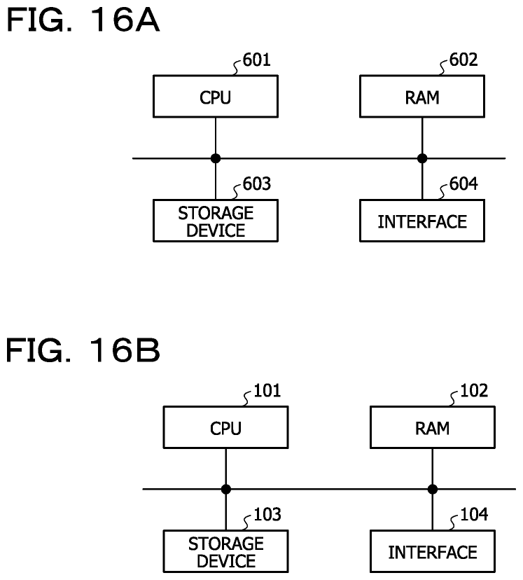

FIG. 16A is a block diagram illustrating a hardware configuration of the control unit 60 of the gate management system 200.

As illustrated in FIG. 16A, the control unit 60 includes a central processing unit (CPU) 601, a random access memory (RAM) 602, a storage device 603, and an interface 604.

The CPU 601 is a central processing unit and includes one or more cores. The RAM 602 is a volatile memory that temporarily stores a program executed by the CPU 601, data processed by the CPU 601, or the like. The storage device 603 is a nonvolatile storage device. As the storage device 603, for example, a read only memory (ROM), a solid state drive (SSD) such as a flash memory, a hard disk to be driven by a hard disk drive, or the like may be used. The storage device 603 stores a control program. The interface 604 is an interface device with an external device. For example, the interface 604 includes an interface device with the camera 10, an interface device with the vein sensor 20, an interface device with the display device 30, an interface device with the actuator 40, and an interface device with the local area network (LAN).

The CPU 601 executes the control program so as to implement the face detection unit 61, the facial feature extraction unit 62, the vein detection unit 63, the vein feature extraction unit 64, and the device control unit 66 of the control unit 60. The face detection unit 61, the facial feature extraction unit 62, the vein detection unit 63, the vein feature extraction unit 64, and the device control unit 66 may use hardware such as a dedicated circuit. Furthermore, the face image storage unit 67 and the vein image storage unit 68 are implemented by the storage device 603.

FIG. 16B is a block diagram illustrating a hardware configuration of the server 100.

As illustrated in FIG. 16B, the server 100 includes a CPU 101, a RAM 102, a storage device 103, and an interface 104.

The CPU 101 is a central processing unit and includes one or more cores. The RAM 102 is a volatile memory that temporarily stores a program executed by the CPU 101, data processed by the CPU 101, or the like. The storage device 103 is a nonvolatile storage device. As the storage device 103, for example, a ROM, a solid state drive (SSD) such as a flash memory, a hard disk to be driven by a hard disk drive, or the like may be used. The storage device 103 stores a program. The interface 104 is an interface device with an external device. For example, the interface 104 includes an interface device with the LAN.

By executing the program by the CPU 101, the list creation unit 11, the vein data reading unit 13, the vein authentication unit 14, and the output unit 15 are implemented. Note that hardware such as a dedicated circuit may be used as the list creation unit 11, the vein data reading unit 13, the vein authentication unit 14, and the output unit 15. Furthermore, the facial feature DB 16, the list storage unit 17, and the vein DB 18 are implemented by the storage device 103.

In the present embodiment, the vein sensor 20 is an example of a sensor provided in a gate.

The vein image captured by the vein sensor 20 or the vein image data acquired from the vein image captured by the vein sensor 20 is an example of biometric information. The face detection unit 61 is an example of an acquisition unit. The face detection unit 61 and the vein data reading unit 13 are examples of a determination unit. The list creation unit 11 and the vein authentication unit 14 are examples of an authentication unit. The output unit 15 is an example of an instruction unit and a suppression unit.

Note that the processing functions described above may be implemented by a computer. In that case, a program in which processing content of functions that a processing device needs to have is described is provided. The program is executed in the computer, whereby the processing functions described above are implemented in the computer. The program in which processing content is described may be recorded in a computer-readable storage medium (note that a carrier wave is excluded).

In a case of distributing the program, for example, the program is sold in a form of a portable storage medium such as a digital versatile disc (DVD) or a compact disc read only memory (CD-ROM) in which the program is recorded. Furthermore, it is also possible to store the program in a storage device of a server computer, and transfer the program from the server computer to another computer via a network.

The computer that executes the program stores, for example, the program recorded in the portable storage medium or the program transferred from the server computer in a storage device of the computer. Then, the computer reads the program from the storage device of the computer, and executes processing according to the program. Note that the computer may also read the program directly from the portable storage medium and execute the processing according to the program. Furthermore, the computer may also sequentially execute the processing according to the received program each time the program is transferred from the server computer.

While the embodiments of the present invention have been described above in detail, the present invention is not limited to such a specific embodiment, and various modifications and alterations may be made within the scope of the gist of the present invention described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An authentication method for a computer to execute a process comprising:
determining whether a face image that satisfies a first criterion is included in a first captured image captured by a camera that is provided so as to include a face of a person who is about to pass through a gate in an imaging range, when biometric information is acquired by a sensor provided in the gate;
when the face image that satisfies the first criterion is included, performing authentication by using the face image included in the first captured image and the biometric information;
when the face image that satisfies the first criterion is not included, instructing the camera to capture a second image; and
performing authentication by using a face image included in the second captured image and the biometric information.

2. The authentication method according to claim 1, wherein the process further comprising
when quality of the acquired biometric information satisfies a second criterion, suppressing an output of a message that requests biometric information again, in a period at least from a time of the instructing to the camera to a time of the authentication by using the face image included in the second captured image and the biometric information.

3. The authentication method according to claim 1, wherein the process further comprising:
acquiring a captured image of the camera at a certain period, until the biometric information is acquired; and
determining whether the face image that satisfies the first criterion is included in at least one of a plurality of captured images captured by the camera.

4. The authentication method according to claim 2, wherein the process further comprising:
acquiring a captured image of the camera at a certain period, until the biometric information with the quality that satisfies the second criterion is acquired; and
determining whether the face image that satisfies the first criterion is included in at least one of a plurality of captured images captured by the camera.

5. The authentication method according to claim 3, wherein the process further comprising:
acquiring a third captured image with a highest quality from among the plurality of captured images captured by the camera;
determining whether the face image that satisfies the first criterion is included in the third captured image;
when the face image that satisfies the first criterion is included in the third captured image, performing authentication by using the face image included in the third captured image and the biometric information; and
when the face image that satisfies the first criterion is not included in the third captured image, instructing the camera to perform imaging.

6. A non-transitory computer-readable storage medium storing an authentication program that causes at least one computer to execute a process, the process comprising:
determining whether a face image that satisfies a first criterion is included in a first captured image captured by a camera that is provided so as to include a face of a person who is about to pass through a gate in an imaging range, when biometric information is acquired by a sensor provided in the gate;
when the face image that satisfies the first criterion is included, performing authentication by using the face image included in the first captured image and the biometric information;
when the face image that satisfies the first criterion is not included, instructing the camera to capture a second image; and
performing authentication by using a face image included in the second captured image and the biometric information.

7. The non-transitory computer-readable storage medium according to claim 6, wherein the process further comprising
when quality of the acquired biometric information satisfies a second criterion, suppressing an output of a message that requests biometric information again, in a period at least from a time of the instructing to the camera to a time of the authentication by using the face image included in the second captured image and the biometric information.

8. The non-transitory computer-readable storage medium according to claim 6, wherein the process further comprising:
acquiring a captured image of the camera at a certain period, until the biometric information is acquired; and
determining whether the face image that satisfies the first criterion is included in at least one of a plurality of captured images captured by the camera.

9. The non-transitory computer-readable storage medium according to claim 7, wherein the process further comprising:
acquiring a captured image of the camera at a certain period, until the biometric information with the quality that satisfies the second criterion is acquired; and
determining whether the face image that satisfies the first criterion is included in at least one of a plurality of captured images captured by the camera.

10. The non-transitory computer-readable storage medium according to claim 8, wherein the process further comprising:
acquiring a third captured image with a highest quality from among the plurality of captured images captured by the camera;
determining whether the face image that satisfies the first criterion is included in the third captured image;
when the face image that satisfies the first criterion is included in the third captured image, performing authentication by using the face image included in the third captured image and the biometric information; and
when the face image that satisfies the first criterion is not included in the third captured image, instructing the camera to perform imaging.

11. An information processing device comprising:
one or more memories; and
one or more processors coupled to the one or more memories and the one or more processors configured to:
determine whether a face image that satisfies a first criterion is included in a first captured image captured by a camera that is provided so as to include a face of a person who is about to pass through a gate in an imaging range, when biometric information is acquired by a sensor provided in the gate,
when the face image that satisfies the first criterion is included, perform authentication by using the face image included in the first captured image and the biometric information,
when the face image that satisfies the first criterion is not included, instruct the camera to capture a second image, and
perform authentication by using a face image included in the second captured image and the biometric information.

12. The information processing device according to claim 11, wherein the one or more processors are further configured to
when quality of the acquired biometric information satisfies a second criterion, suppress an output of a message that requests biometric information again, in a period at least from a time of the instructing to the camera to a time of the authentication by using the face image included in the second captured image and the biometric information.

13. The information processing device according to claim 11, wherein the one or more processors are further configured to:
acquire a captured image of the camera at a certain period, until the biometric information is acquired, and
determine whether the face image that satisfies the first criterion is included in at least one of a plurality of captured images captured by the camera.

14. The information processing device according to claim 12, wherein the one or more processors are further configured to:
acquire a captured image of the camera at a certain period, until the biometric information with the quality that satisfies the second criterion is acquired, and
determine whether the face image that satisfies the first criterion is included in at least one of a plurality of captured images captured by the camera.

15. The information processing device according to claim 13, wherein the one or more processors are further configured to:
acquire a third captured image with a highest quality from among the plurality of captured images captured by the camera,
determine whether the face image that satisfies the first criterion is included in the third captured image,
when the face image that satisfies the first criterion is included in the third captured image, perform authentication by using the face image included in the third captured image and the biometric information, and
when the face image that satisfies the first criterion is not included in the third captured image, instruct the camera to perform imaging.
